(19) United States
(12) Patent Application Publication
(10) Pub. No.: US 2025/0157104 A1
(43) Pub. Date: May 15, 2025

(54) ICONIFICATION FUNCTIONALITY FOR DATA VISUALIZATIONS

(71) Applicant: Oracle International Corporation, Redwood City, CA (US)

(72) Inventors: Michael Senada Malak, Sarasota, FL (US); Brandon Dean Yukio Tomooka, Anaheim, CA (US); Rogelio Aaron Bernal Guardado, Aguascalientes (MX); Chaohui Yu, Queens, NY (US); Kalyan Kumar Beemanapalli, Danville, CA (US)

(21) Appl. No.: 18/507,592

(22) Filed: Nov. 13, 2023

(51) Int. Cl. G06T 11/60; G06T 11/20

(52) U.S. Cl. CPC G06T 11/60; G06T 11/206

(57) ABSTRACT

Systems and methods for providing an iconification functionality for generation of data visualizations are described herein. For example, a method of generating iconified visualizations includes receiving, by an iconification function, a visualization request from a client device, determining, by a prompt engine of the iconification function, data to iconize based on the visualization request, and generating, by the prompt engine, a first prompt based on the data to iconize. The method also includes determining, by the iconification function, descriptors based on the first prompt, generating, by the prompt engine, a second prompt based on the descriptors, and generating, by the iconification function, an image based on the second prompt. The method further includes generating, by the iconification function, an icon image based on the image, generating, by the iconification function, a visualization including the icon image, and transmitting, by the iconification function, the visualization to the client device.

### FIELD

The present application generally relates to data visualizations, such as charts and graphs, and more particularly relates to an iconification functionality for data visualizations that generates icon images for use within the data visualizations.

### BACKGROUND

Data visualizations, such as charts and graphs, serve as invaluable tools for data analysis, especially for organizations dealing with substantial volumes of information. Data visualizations, which are referred to herein as “visualizations,” contain visual representations that provide a concise and accessible means of conveying complex data, by for example, making it easier for viewers to grasp key insights and trends at a glance. In the realm of high-volume data management, where the sheer quantity of information can be overwhelming, visualizations act as efficient aids in distilling critical findings. By condensing extensive datasets into clear, digestible graphics, organizations can streamline the decision-making process and foster data-driven decision-making. This enhanced understanding is particularly crucial for executives, managers, and decision-makers who need to quickly assess the state of affairs, allocate resources, and devise strategies in a fast-paced, data-driven environment.

Moreover, visualizations enhance the communicative power of data in high-volume data management. These visuals enable teams to share insights with diverse stakeholders, including non-technical audiences, in a compelling and comprehensible manner. When dealing with large datasets, conveying findings solely through numbers or lengthy reports can often lead to confusion and information overload. Visualizations, on the other hand, transform data into compelling narratives that engage the audience and facilitate better information retention. In the context of data-rich organizations, these visual representations are pivotal for cross-functional collaboration, ensuring that insights are effectively communicated to various departments, from marketing and finance to product development and operations. This not only improves the overall data culture within the organization but also accelerates the adoption of data-informed decision-making across the board.

Current visualizations, however, are generated using standard datapoint representations, such as dots, dashes, and lines. Reliance on these means of generating visualizations often falls short in effectively conveying information. For example, the limited expressiveness of such minimalistic representations can hinder accurate portrayal of multi-dimensional data or complex relationships, or in some cases, require a viewer to turn to other elements of the visualization, such as labels, to readily appreciate the information being conveyed by the standard datapoint representations. Additionally, standard datapoint representations within visualizations may not adequately cater to diverse audiences, including those with different cognitive styles or accessibility needs, limiting the inclusivity of the visualization.

As such, improved systems and techniques for generating visualizations containing enhanced visual elements, such as icon images, are needed.

### Overview

Technology is disclosed herein for providing one or more iconification functionalities for use within visualizations. In particular, the techniques and systems provided herein allow for generation of icon images based on underlying data to be quantified and represented within a visualization. To generate icon images based on the underlying data to which the icon image quantifies, the iconification functionality is provided. The iconification functionality generates an icon image based on a visualization request. The visualization request may be a request submitted by a client device to generate the visualization. Responsive to the visualization request, data to be iconized may be determined. Once determined, a first prompt may be generated for requesting a list of descriptors for the data to be iconized. The first prompt is then submitted to a content generator, such as a large language model (LLM) for generation of a list of descriptors for the data to be iconized.

Responsive to generation of the descriptors, a second prompt is configured to requesting an image to be generated based on the descriptors. The second prompt is then submitted to another content generator, such as a text-to-image generator, for generation of the image. The generated image may be modified or reformatted into an icon image. For example, the image may be compressed to a reduced size and a background of the image may be removed. Once the icon image is generated, a visualization may be generated using the icon image as a datapoint to quantify the underlying data represented within the visualization. In some cases, the visualization may be animated, and in such cases, the icon images may be animated within the visualization.

This Overview is provided to introduce a selection of concepts in a simplified form that are further described below in the Detailed Description. It may be understood that this Overview is not intended to identify key features or essential features of the claimed subject matter, nor is it intended to be used to limit the scope of the claimed subject matter.

### BRIEF DESCRIPTION OF THE DRAWINGS

The accompanying drawings, which are incorporated into and constitute a part of this specification, illustrate one or more certain aspects and, together with the description of the example, serve to explain the principles and implementations of the certain examples.

FIG. 1 illustrates an example operational environment for a system providing one or more iconification functionalities, according to an embodiment herein;

FIG. 2 illustrates an example system for providing one or more iconification functionalities, according to an embodiment herein;

FIG. 3 illustrates an example process for providing one or more iconification functionalities, according to an embodiment herein;

FIG. 4 illustrates another example system for providing one or more iconification functionalities, according to an embodiment herein;

FIG. 5 illustrates a flow for providing one or more iconification functionalities, according to an embodiment herein;

FIGS. 6A-6C illustrate example graphical user interfaces (GUIs) showing various user experiences for providing one or more of the iconification functions, according to an embodiment herein; and

FIG. 7 shows an example computing device suitable for providing one or more iconification functionalities, according to an embodiment herein.

### DETAILED DESCRIPTION

Organizations are handling increasingly growing volumes of data and information spanning extensive subject matters, formats, and databases. Due to the growing volume of data, it can become increasingly difficult for users to consume and parse through the data to identify and see trends or observations within the data. Moreover, even if a user identifies an observation or trend in the data, the user may not readily appreciate the various dimensions or factors playing into that observation.

A common means for viewing data is visualizations. Visualizations are visual representations of data, such as charts or graphs. Visualizations serve as valuable tools for data analysis, especially for organizations handling large volumes of information. As noted above, visualizations provide concise and accessible means of conveying information by providing visual representations of key insights. That is, visualizations allow viewers to grasp key insights and trends at a glance. In a fast-paced and data-driven environment, visualizations are a useful tool that condense extensive data into an easily digestible format to facilitate decision-making.

Current visualizations, such as charts and graphs, however, use standard datapoint representations, such as dots, dashes, and lines, to quantify data within a visualization. Standard data point representations limit expressiveness of the conveyed data, often requiring viewers to turn to other visualization elements, such as labels, to appreciate the information that is being conveyed. As can be appreciated, the minimalistic style of standard datapoint representations may limit the inclusivity of the visualization for diverse audiences, such as audiences with a range of cognitive styles and accessibility needs.

To provide a more efficient and inclusive means of conveying information via a visualization, systems and methods for providing an iconification functionality are provided herein. As will be described in greater detail below, the iconification functionality generates visualizations, such as a chart or graph, including icon images as datapoint representations. That is, instead of data being quantified using standard datapoint representations, the data is quantified using an icon image.

Moreover, the icon image is generated using the iconification functionality based on the underlying data to which the icon image represents. For example, if the data illustrated on the visualization relates to cars, such as how many cars were sold last year at a given dealership, then the icon image used to represent the sales data may be a car. Following the same example, if the visualization is illustrating a comparison of the sales data between cars and trucks sold at the dealership, then the sales data for trucks may be represented using icon images of trucks.

As can be appreciated, by generating icon images based on the underlying data to which the icon images represent provides another dimension to the information being conveyed. That is, a viewer need not turn to the visualization labels to appreciate the data that is being conveyed. The added dimension of using icon images that are generated based on the data that they represent also extends the inclusiveness of the visualization, allowing diverse audiences having a range of cognitive styles and accessibility needs, to readily appreciate the underlying data. Moreover, using icon images within visualizations more readily engages viewers, thereby increasing attention and information conveyed by the visualizations.

To generate icon images based on the underlying data to which the icon image quantifies, the iconification functionality is provided. As noted above, the iconification functionality generates an icon image based on data to which it is quantifying. In some cases, a user may specify the data that is to be used within the visualization. In other cases, the iconification functionality may gather the data based on user data. For example, the iconification functionality, or another application in communication with the iconification functionality, may gather user data based on a client device associated with the user. That is, a user may interact with various data and the iconification functionality may identify a trend or observation based on the user's interaction with the data. As such, in some cases, the iconification functionality may prompt the user with a visualization capturing the trend or observation.

Once the data for the visualization is determined, the iconification functionality generates an icon image based on the data. The visualization is then generated using the icon image as the datapoint representation for that data. In some cases, a user may request that the visualization be animated. As such, the iconification functionality may animate the icon images within the visualization based on the user's request.

As noted above, a benefit of the iconification functionality is that it provides another dimension over traditional data visualization techniques. Specifically, the iconification functionality generates icon images based on the data that the icon image is quantifying. Not only does the use of icon images over standard datapoint representations provide another dimension of information being conveyed, but it also extends the audience of the visualization to include those with diverse cognitive styles and accessibility needs. Moreover, it allows viewers to appreciate the data being conveyed faster over conventional techniques. As such, the systems and techniques discussed herein provide for improved and more efficient means of identifying, addressing, and visualizing issues, trends, or observations present in large volumes of data.

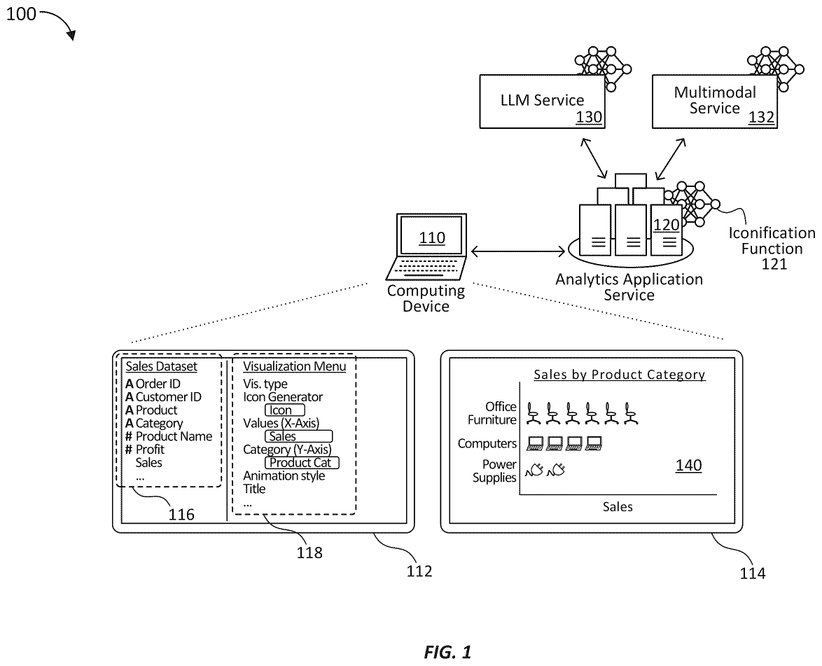

Turning now to the Figures, FIG. 1 illustrates operational environment 100 for a system providing one or more iconification functionalities, according to an embodiment herein. As illustrated, the operational environment 100 includes a computing or client device 110, an application service 120, a large language model (LLM) service 130, and a multimodal service 132. The application service 120 hosts an application to endpoints such as the client device 110. The client device 110 executes applications locally that provide a local user experience and that interface with the application service 120. The applications running locally with respect to client device 110 may be natively installed and executed applications, browser-based applications, mobile applications, streamed applications, or any other type of application capable of interfacing with the application service 120 and providing a user experience, such as user experiences 112 and 114 displayed on client device 110. Applications provided by the application service 120 may execute in a stand-alone manner, within the context of another application such as a presentation application or word processing application, with a spreadsheet functionality, or in some other manner entirely.

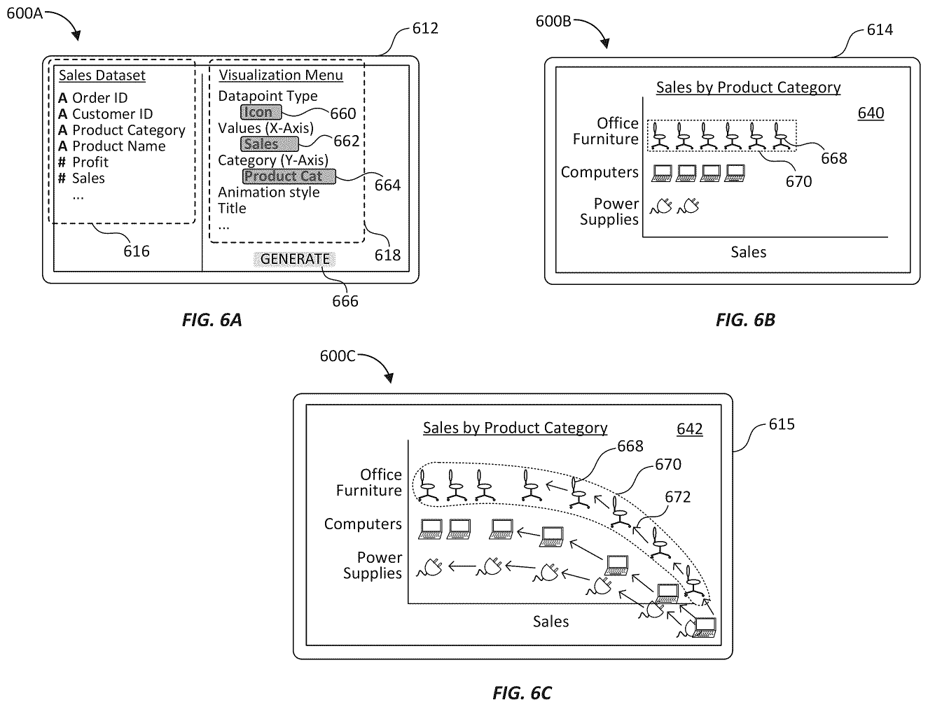

As described herein, the client device 110 is representative of a computing device, such as a laptop or desktop computer, or mobile computing device, such as a tablet computer or cellular phone, of which the computing device is broadly representative. The client device 110 communicates with application service 120 via one or more internets and intranets, the Internet, wired or wireless networks, local area networks (LANs), wide area networks (WANs), and any other type of network or combination thereof. A user may interact with one or more of the applications provided by the application service 120 using a user interface of the application displayed on client device 110. For example, as illustrated, a user may be provided with the user experiences 112 and 114 when displayed on the client device 110. Prompts 116, 118, and 140 illustrate an exemplary user experience of an application environment for an application hosted by the application service 120, according to an embodiment herein. Specifically, the illustrated user experiences 112 and 114, including the prompts 116, 118, and 140, are described in greater detail below with respect to FIGS. 6A-6C.

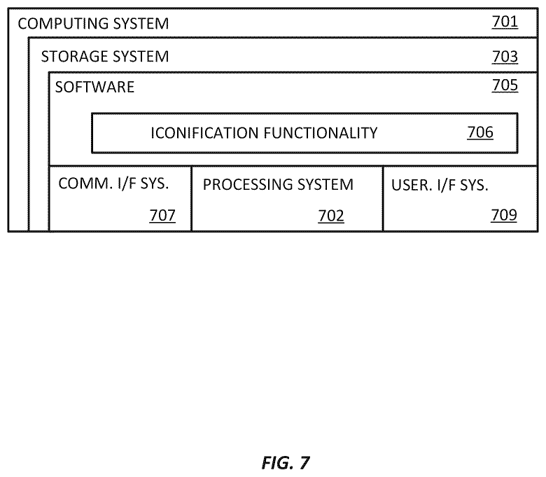

In the illustrated example, the application service 120 is an analytics application service and is representative of one or more computing services capable of hosting an application and interfacing with the client device 110 and with iconification function 121. Generally, the application service 120 employs one or more server computers co-located or distributed across one or more data centers connected to the client device 110. Examples of such servers include web servers, application servers, virtual or physical (bare metal) servers, or any combination or variation thereof, of which the computing system 701 in FIG. 7 is broadly representative. The application service 120 may communicate with client device 110 via one or more internets, intranets, the Internet, wired and wireless networks, local area networks (LANs), wide area networks (WANs), and any other type of network or combination thereof. Examples of services or sub-services of the application service 120 include—but are not limited to—voice and video conferencing services, collaboration services, file storage services, and other application services. In some examples, the application service 120 may provide a suite of applications and services with respect to a variety of computing workloads such as office productivity tasks, email, chat, voice and video, and so on.

As noted above, the application service 120 is an analytics application service in the illustrated example. As such, the application service 120 acts as a platform for processing and interpreting data, allowing client devices, such as the client device 110, to extract valuable information and patterns from their data. For example, the application service 120 processes and organizes large volumes of data from a variety of sources. The application service 120 then may employ advanced algorithms and statistical techniques to analyze the data, uncovering meaningful patterns present in the data. As part of identifying trends or observations present within the data, the applications service 120 generates one or more visualizations, such as charts and/or graphs. As noted above, traditional visualization techniques involve the use of standard datapoint representations to represent quantified data. To provide heightened visualizations that provide an additional dimension of data visualization, the application service 120 includes the iconification function 121.

The iconification function 121 may provide one or more iconification functionalities, as provided herein. For example, the iconification function 121 may communicate (as illustrated) with or include the LLM service 130 and/or the multimodal service 132. That is, the iconification function 121 may be representative of one or more computing services capable of hosting content generation architecture and/or communicating with the application service 120. The iconification function 121 may be implemented in the context of one or more server computers co-located or distributed across one or more data centers. In some embodiments, the iconification function 121 may be hosted by the same provider as the provider for the application service 120, while in other embodiments, the iconification function 121 may be hosted by a third party. It should be appreciated that while the iconification function 121 is illustrated as part of the application service 120, the iconification function 121 may be separate from the application service 120, and in some cases, hosted by a separate party.

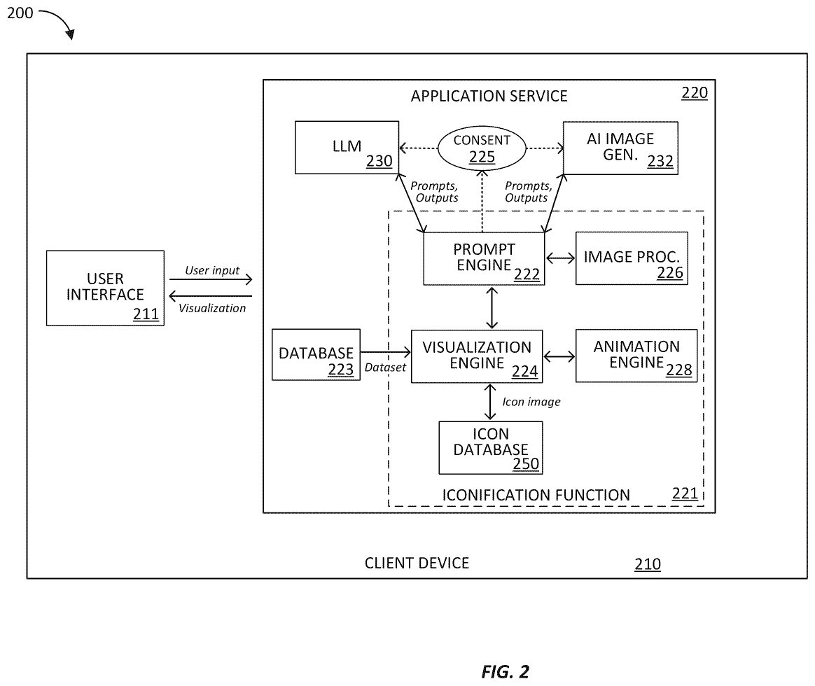

As noted above, the iconification function 121 may host or communicate with a LLM service 130 and the multimodal service 132. The LLM service 130 and/or the multimodal service 132 may include or be representative of a deep learning AI model, such as BERT, ERNIE, T5, XLNet, or of a generative pretrained transformer (GPT) computing architecture, such as GPT-3®, GPT-3.5, ChatGPT®, or GPT-4™. In an exemplary embodiment, the LLM service 130 is a text-to-text content generator, such as GPT-Neo, Bloom, or GPT-4. In another exemplary embodiment, the multimodal service 132 is a text-to-image content generator, such as Stable Diffusion™ or DALL-E. As will be described in greater detail below with respect to FIGS. 2-5, the application service 120 may host or include the LLM service 130 and/or the multimodal service 132. In some embodiments, one or both of the LLM service 130 and/or the multimodal service 132 are part of the iconification function 121.

The iconification function 121 may be executed by or in association with a user's interaction with a user interface for an application hosted by the application service 120. The iconification function 121 may include an artificial intelligence (AI) or machine learning model (not shown) that analyzes a user's interaction with one or more applications hosted by the application service 120. Based on the user's interactions with the one or more applications, the iconification function 121 may determine a trend or observation. In some cases, the application service 120 may monitor the user's interactions and determine the trend or observation based on the interactions. Once the trend or observation is determined within the user's data, the iconification function 121 may generate a visualization to illustrate the trend or observation for the user. That is, the iconification function 121 generates a visualization based on data identified based on the user's interaction with the data.

In an illustrative example, a user of the client device 110 interacts with the application service 120 via a user interface displaying one or more of the user experiences 112 and 114. That is, the user may be provided with the user experiences 112 and 114 via an application environment provided by the application service 120. As illustrated in the user experiences 112 and 114, the application environment displays various options for interacting with data hosted by the application service 120. In particular, the user experience 112 provides prompt 116 identifying datasets and the prompt 118 for submitting a visualization request. The user experience 114 then provides the prompt 140 illustrating a visualization generated by the iconification function 121. The user experiences 112 and 114 are described in greater detail below with respect to FIGS. 6A-6C.

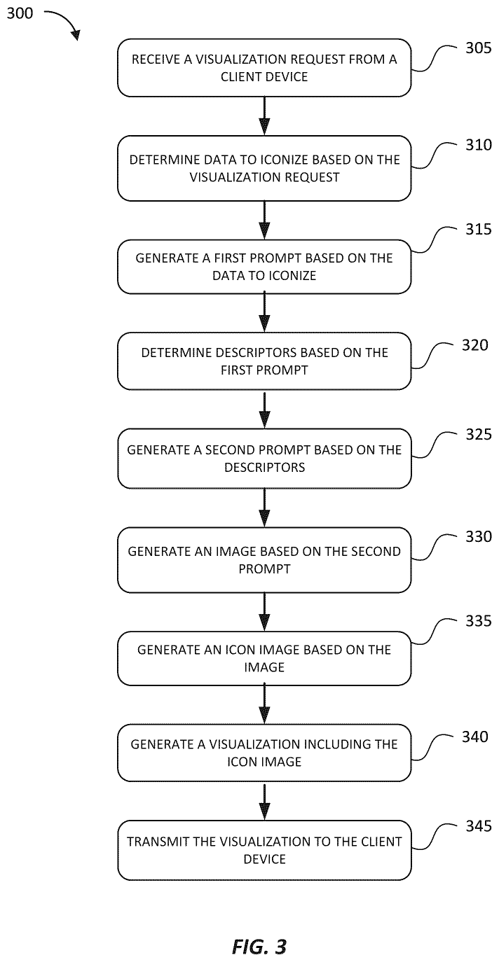

Referring now to FIGS. 2 and 3, FIG. 2, FIG. 2 illustrates a system 200 for providing one or more iconification functionalities and FIG. 3 illustrates an example process 300 for providing the iconification functionality, according to an embodiment herein. For ease of explanation, FIGS. 2 and 3 are described together and with reference to FIG. 1, however, it should be appreciated that elements, steps, or components from any other Figure provided herein may be applicable.

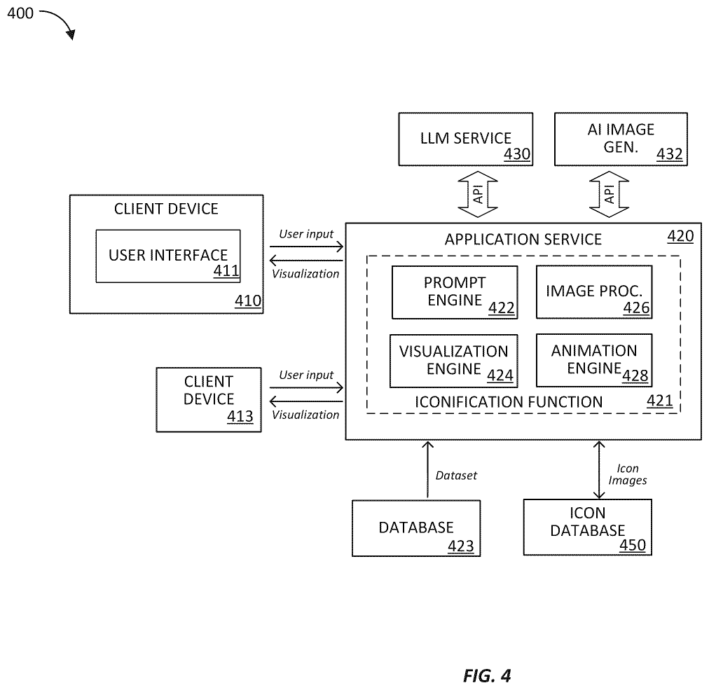

Starting with FIG. 2, the system 200 illustrates an example in which the application service 220 is executed locally by a client device 210. That is, the application service 220, which may be the same or similar to the application service 120, may be installed and executed directly on the client device 210, utilizing the client device's 210 processing power and resources for operation. The client device 210 may be the same or similar to the client device 110. As can be appreciated, by locally executing the application service 220, or a portion thereof, can allow the application service 220 to function independently of a constant internet connection and/or provide faster response times through local processing. In such cases, the application service 220, or the portion thereof that is installed on the client device 210 may include software or instructions for providing the iconification functionality, such as instructions to the process 300 provided in FIG. 3. In alternative cases, the application service 220 may be remotely executed, such as the embodiment illustrated in FIG. 4.

With reference to FIG. 3, the process 300 for providing one or more of the iconification functionalities includes receiving a visualization request from a client device 210 (305). The visualization request may be submitted via a user interface 211 of the client device 210. The user interface 211 may be a means through which a user of the client device 210 communicates and interacts with the application service 220. For example, the user experiences 112 and 114 may be provided via the user interface 211 to a viewing user. As illustrated, the visualization request may be received by the application service 220. In particular, the visualization request may be received by the iconification function 221 of the applications service 220. In scenarios in which the iconification function 221 is separate from the application service 220, the application service 220 may transmit the visualization request to the iconification function 221.

Responsive to receiving the visualization request, the iconification function 221 determines data to be iconized based on the visualization request (310). The data to be iconized may be selected by a user when submitting the visualization request. For example, the visualization request may include text data or selection of data that the user desires to be quantified in the visualization. In an illustrative example, a user may request a visualization charting the sales of various products, such as office furniture, computers, and power supplies. As such, the visualization request may include selection of the sales data corresponding to the categories of office furniture, computers, and power supplies.

In an alternative case, the data to be iconized may be determined based on user data. As described above, the application service 220, or an application in communication with the application service 220, may gather user data based on the user's interaction with data. For example, the application service 220 may determine that the user interacts with product sales data. In particular, the application service 220 may identify a trend or observation present within the product sales data that the user interacts with. As such, the application service 220 may prompt the user to indicate that the trend or observation was identified. Responsive to the prompt, the user may request a visualization of the trend or observation. As such, the visualization request may be submitted to generate the visualization of the trend or observation. As can be appreciated, the prompt provided to the user via the user interface 211 identifying the trend or observation may include an option to request a visualization of the trend or observation, that upon selection by the user, submits the visualization request.

The data to be iconized may be extracted from user data using a variety of techniques. In one embodiment, the iconification function 221 may determine the underlying data associated with the visualization request and then extract the data from the underlying data. For example, the application service 220 may include a database 223. The database 223 stores the datasets corresponding to the data to be iconized. Following the above example, the database 223 may host or store the datasets corresponding to the product sales data for furniture, computers, and office supplies. In some cases, the datasets may be hosted in a document. If the document contains a table having columns and rows, then the iconification function 221 may extract the data to be iconized from the values within the cells of the tables. That is, if the table contains a column labeled “Products” with values like “furniture,” “computers,” and “office supplies” within the underlying cells, then the values may serve as the raw text for the data to be iconized. Alternatively, the column name, “Products” itself may be the raw text used as the data to be iconized.

In yet another example, if a column contains medium-length text, such as a column containing comments, then the contents within the column may be clustered by topics and resulting short text labels may be used as the data for icon generation. Example techniques for clustering contents within a column containing medium-length text are provided in U.S. Patent Publication No. 2023/0057706, titled “Text Analytics and User Interface,” which is hereby incorporated by reference.

As illustrated, the iconification function 221 includes a variety of components, such as a prompt engine 222, a visualization engine 224, an image processor 226, an animation engine 228, and an icon database 250. One or more of these components of the iconification function 221 may be rearranged, combined, or eliminated in various embodiments. For example, the visualization engine 224 may be or include the animation engine 228 in another embodiment. For ease of explanation, however, the following discussion will describe the example with the components a separate components of the iconification function 221.

As noted above, the iconification function 221 determines the data to be iconized responsive to receiving the visualization request. In particular, the prompt engine 222 of the iconification function 221 may determine the data to be iconized responsive to receiving the visualization request. For example, if the visualization request is for a visualization of the product sales data for furniture, computers and office supplies then the prompt engine 222 may determine that the data to be iconized includes sales data for furniture, sales data for computers, and sales data for office supplies.

Once the data to be iconized is determined, such as the product sales data of the above example, the prompt engine 222 generates a first prompt based on the visualization request (315). The first prompt may be a request for descriptors of the data to be iconized. For example, the prompt engine 222 may determine that the product sales data includes the three categories: sales data for furniture, sales data for computers, and sales data for office supplies. The prompt engine 222 may also determine that the sales data includes the three categories of furniture, computers, and office supplies. As such, the prompt engine 222 may generate a first prompt requesting descriptors for each category: furniture, computers, and office supplies. In some cases, a separate prompt may be generated for each individual category (e.g., a first prompt for descriptors of furniture, a second prompt for descriptors of computers, and a third prompt of descriptors of office supplies). In some embodiments, the visualization request may be for a single category of sales data, such as furniture sales data. As such, the first prompt may include descriptors for furniture. For ease of explanation, the following discussion is going to be for a visualization request for a single product sales data, such as for furniture.

The first prompt may be a boilerplate or template prompt in which the requested data to be iconized is inserted. For example, the first prompt may be or include a request for “a simple icon representing ‘furniture’ would contain the following three graphical elements:______” or “provide three graphical elements representing the term ‘furniture.’” As can be appreciated, by having the first prompt include a template or form language when requesting the descriptors of the data to be iconized, this can ensure the format of descriptors generated remains consistent between subsequent visualization requests. In some cases, to ensure consistency between visualization requests, a randomness amount for the content generator (e.g., the LLM 230) may be set to zero or a consistent seed to the pseudo-random number generator may be provided for each request. As can be appreciated, similar steps to ensure consistency may be taken with respect to the AI image generator 232.

Once the first prompt is generated by the prompt engine 222, the descriptors are determined based on the first prompt (320). For example, the first prompt is submitted to a content generator, such as the LLM 230. The LLM 230 may be a text-to-text content generator, such as GPT-Neo™, Bloom, or GPT-4™. As such, the LLM 230 generates descriptors for the data to be iconized based on the first prompt. For example, the LLM 230 may generate a response to the first prompt, as described in the above example, to be “a simple icon representing ‘furniture’ would contain the following three graphical elements: a sofa, a table, and a lamp.” That is, the LLM 230 may generate the descriptors ‘a sofa, a table, and a lamp’ responsive to the first prompt. Once the descriptors are generated, the LLM 230 provides the descriptors back to the prompt engine 222.

A second prompt is then generated based on the descriptors (325). That is, once the prompt engine 222 receives the descriptors back from the LLM 230, the prompt engine 222 generates a second prompt. The second prompt may include a request for an image to be generated based on the descriptors. For example, the second prompt may be generated based on the descriptors and the first prompt. Following the above example, the second prompt may be “a simple icon representing ‘furniture’ containing the following three graphical elements: a sofa, a table, and a lamp.”

Once the second prompt is generated, the second prompt may be submitted to the AI image generator 232, which may be the same or similar to the multimodal service 132. That is, an image is generated based on the second prompt (330). For example, the prompt engine 222 transmits the second prompt to the AI image generator 232 for generation of an image based on the second prompt. In some embodiments, the response generated by the LLM 230 may be submitted directly to the AI image generator 232 without generation of the second prompt by the prompt engine 222. In such cases, the response generated by the LLM 230 may be in a format similar to that of the second prompt, such that it can be directly submitted to the AI image generator 232.

The AI image generator 232 may be a text-to-image content generator, such as for example, Stable Diffusion™ or DALL-E. As such, the AI image generator 232 generates an image based on the second prompt. The generated image is based off of the descriptors present in the second prompt. Once the image is generated, then an icon image is generated based on the image (335). For example, upon generation of the image by the AI image generator 232, the image may be submitted to the image processor 226, either directly from the AI image generator 232 or via the prompt engine 222 as illustrated. The image processor 226 provides various image processing functions, such as filtering, enhancement, resizing, and feature extraction. For example, to generate the icon image from the image, the image processor 226 resizes the image to a reduced size associated with an icon, such as by compressing the image. Additionally, the image processor 226 may remove a background in the image such that the icon is transparent or may extract a main feature from the image. For example, if an image of an office chair is generated, then the image processor 226 may remove everything except the office chair from the image, including the background, and compress the image to generate the icon image.

In some embodiments, as part of submitting the first prompt to the LLM 230 and/or the AI image generator 232, the client device 210 may first provide consent 225. That is, the client device 210 may be prompted to provide consent 255 or using one or more programs hosted by the application service 220, in particular for using the iconification function 221. As would be appreciated by those skilled in the art, the consent 225 may allow the iconification function 221, and functions therein, to use data associated with the client device 210, such as the user data for the client device 210, for generation of the icon image. In some embodiments, the consent 225 may also allow the iconification function 221 to use the user data to determine data to be iconize. In other embodiments, the consent 225 may allow use of the LLM 230 to generate the descriptors based on the first prompt. Similarly, the consent 225 may allow the AI image generator 232 to generate the image based on the second prompt. In other words, the consent 225 may be for one or more functions or components of the system 200, or for all functions or components of the iconification function 221.

Obtaining the consent 225 as part of the iconification function 221 may be part of a larger data privacy strategy employed by the application service 220. For example, to ensure compliance with data privacy regulations, the iconification function 221 may employ various protection measures, such as encryption, access controls, and secure storage to safeguard sensitive information from unauthorized access to data hosted and stored by the application service 220. That is, the iconification function 221 may establish clear data usage policies, that may be outlined to user via the consent 225, providing transparency on how data associated with the client device 210 is utilized for content generation via the LLM 230 and/or the AI image generator 232.

In some cases, the consent 225 may also function as a copyright filter. A copyright filter, in the context of a content generators, such as the LLM 230 and the AI image generator 232, functions as a mechanism to ensure that the generated content does not infringe upon existing copyright protections. In an example, a copyright filter operates by analyzing the input to the content generators (e.g., the first prompt and/or the second prompt) and cross-references it with a vast database of copyrighted material. As such, the consent 225, when employing a copyright function, utilizes complex algorithms and machine learning techniques to identify potential matches between the input and copyrighted content. If a match is detected, the filter may automatically flag the content, prevent its generation, or recommend necessary modifications to make it compliant with copyright laws.

Once the image icon is generated, then a visualization is generated using the icon image (340). For example, the visualization engine 224 generates a visualization using the icon image to represent the data within the visualization. The visualization is generated based on the visualization request, and as such, may include additional information, such as axis labels, titles, etc. Following the above example, the visualization may include a chart of the sales data for furniture, computers, and office supplies. As such, an icon image may be generated for each of the data categories (e.g., furniture, computers, and office supplies). The icon image for each data category may be used as a datapoint to quantify the associated data. As such, the chart generated by the visualization engine 224 includes the icon images for each data category. This example will be further described in detail with respect to FIGS. 6A-6C.

Once the visualization is generated by the visualization engine 224, the visualization is transmitted to the client device 210 (345). Since the iconification function 221 is locally executed, transmission of the visualization to the client device 210 may include displaying the visualization via the user interface 211 on the client device 210.

In some embodiments, the visualization request includes a request to animate the visualization. For example, the icon images may be animated within the visualization, such as flying in or out, appearing or fading out, and the like. In such cases, the animation engine 228 may animate the visualization. That is, once the visualization is generated, the visualization, along with the visualization request may be submitted to the animation engine 228 for animation. Once the visualization is animated, then the animated visualization may be transmitted to the client device 210 (e.g., provided via the user interface 211 to the user).

Once generated, the icon image may be encoded into text by the iconification function 221. Encoding the icon image into text may allow the icon image to be stored in a database. For example, BinHex techniques may be used to encode the icon image for storage. Once encoded the icon image may be stored in the icon database 250. In some cases, the icon image may be stored within the icon database 250 without being encoded to text. Instead, the icon image, in image format, may be stored within the icon database 250. Storing the icon images within the icon database 250 can allow the icon image to be used for subsequent visualization request. For example, if the client device 210 submits a second visualization request that includes data to iconized relating to furniture, then the iconification function 221 may first query the icon database 250 for previously generated icon images relating to furniture before generating a new icon image. Since an icon image for furniture is already generated, the iconification function 221 may provide the icon image for furniture stored in the icon database 250 as a suggested icon image for the second visualization request instead of generating a new icon image. As can be appreciated, this may reduce the computing resource needs of the client device 210, thereby saving time and cost associated with generating a new icon image. If a user associated with the client device 210 approves of the furniture icon image, then the visualization for the second visualization request uses the furniture icon image from the icon database 250. If the user associated with the client device 210 does not approve of the furniture icon image, then the iconification function 221 generates a new icon image based on the second visualization request.

Referring now to FIG. 4, FIG. 4 illustrates another example system 400 for providing one or more iconification functionalities. The system 400 may be similar to the system 200 except that an application service 420, along with an iconification function 421, is hosted and executed remotely from a client device 410. As illustrated, the application service 420 may be the same or similar to the application service 220. For example, the application service 420 includes the iconification function 421. The iconification function 421 includes a prompt engine 422, a visualization engine 424, an image processor 426, and an animation engine 428, each of which may be the same or similar to the corresponding component from the system 200.

As shown, the client device 410 includes a user interface 411 for interacting with the application service 420. The user interface 411 may be the same or similar to the user interface 211 in that a user of the client device 410 can submit a visualization request to the application service 420. However, instead of the application service 420 being locally executed, the application service 420 is remote from the client device 410, such as illustrated in FIG. 1 by the operational environment 100. As such, the visualization request from the client device 410 may be transmitted to the application service 420 via one or more internets and intranets, the Internet, wired or wireless networks, local area networks (LANs), wide area networks (WANs), and any other type of network or combination thereof.

Once the application service 420, in particular the iconification function 421 receives the visualization request, then the iconification function 421 may perform one or more of the iconification functionalities as described above with reference to the process 300 with slight variations. The variations to the process 300 performed by the iconification function 421 relate to the communication between the iconification function 421 and the content generators used to generate the icon image. For example, unlike the system 200, an LLM service 430 and an AI image generator 432 are not part of the iconification function 421. Instead, the LLM service 430, which may be the same or similar to the LLM 230, may be separate from the application service 420. For example, the LLM service 430 may be hosted by a third party. Similarly, the AI image generator 432, which may be the same or similar to the AI image generator 232, is separate from the application service 420 and may be hosted by a third party. As such, the LLM service 430 and the AI image generator 432 may communicate with the application service 420 via an application programming interface (API), as illustrated.

Similar to the system 200, datasets associated with the data to be iconized may be hosted by a database 423. As illustrated, the database 423 may be separate from the application service 420, however, it should be appreciated that the database 423 may be hosted by the same party that hosts the application service 420. As such, when the visualization request is received by the iconification function 421, the database 423 may be queried for datasets corresponding to data identified in the visualization request. As described above, the data identified in the visualization request may be provided by a user of the client device 410 or may be identified by the application service 420 based on user data associated with the user of the client device 410.

The system 400 also includes icon database 450. The icon database 450 may be the same or similar to the icon database 250, except that it is separate from the application service 420. For example, the icon database 450 may be hosted by a third party. Similar to the icon database 250, the icon database 450 stores icon images that were previously generated by the iconification function 421. Storing the icon images within the icon database 250 can allow the icon image to be used for subsequent visualization request. For example, if a second client device 413 submits a visualization request that includes data to iconized relating to furniture, then the iconification function 421 may first query the icon database 450 for previously generated icon images relating to furniture before generating a new icon image. Since an icon image for furniture was generated previously based on the visualization request from the client device 410, the iconification function 421 may provide the icon image for furniture stored in the icon database 450 as a suggested icon image to the second client device 413 instead of generating a new icon image. As can be appreciated, this may reduce the computing resource needs, thereby saving time and cost associated with generating a new icon image. If the second client device 413 approves of the furniture icon image, then the visualization for the second client device 413 uses the furniture icon image from the icon database 450. If the second client device 413 does not approve of the furniture icon image, then the iconification function 421 generates a new icon image for the second client device 413 based on a visualization request from the second client device 413.

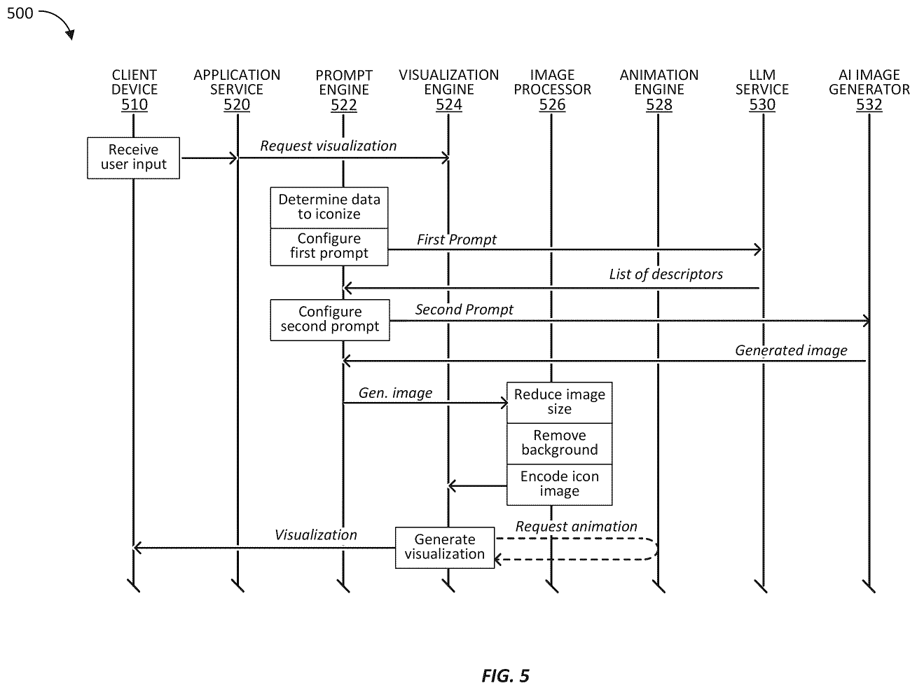

Referring now to FIG. 5, FIG. 5 illustrates a flow 500 for providing one or more iconification functionalities, according to an embodiment herein. For ease of discussion, reference is made to FIGS. 2, however, it should be appreciated that components or systems of any of the other Figures are equally applicable.

As illustrated, the flow 500 is initiated when a client device 510, such as the client device 210, receives user input. In some cases, the user input includes a request for a visualization. In other cases, the user input may include user interaction with data, as described above. The user input may be with respect to an application service 520. The application service 520 may be the same or similar to the application service 220. For example, the application service 220 may provide one or more analytic functions or applications to a user of the client device 510. The user may interact with the application service 520 via a user interface, such as the user interface 211.

Once the user input is received by the application service 520, a visualization request may be submitted to a visualization engine 524. The visualization engine 524 may be the same or similar to the visualization engine 224, by for example, being part of the iconification function 221. As described above the visualization engine 524 may generate visualizations, such as charts, graphs, and the like, based on data associated with the application service 520. In an illustrative example, a user of the client device 510 may submit a visualization request to the visualization engine 524, via the application service 520, for generation of a chart illustrating various data.

Once the visualization engine 524 receives the visualization request, a prompt engine 522, which may be the same or similar to the prompt engine 222, may determine data to be iconized. Since the prompt engine 522 and the visualization engine 524 are part of the iconification function 221, receipt of the visualization request by the visualization engine 524 may be also received by the prompt engine 522 or may be automatically routed to the prompt engine 522 for generation of the first prompt.

After the data to be iconized is determined, the prompt engine 522 then configures a first prompt. As described above, the first prompt may include a request for descriptors of the data. In some cases, the first prompt may follow a template or use boilerplate language to ensure consistency between request from the content generator. Once configured, the first prompt is transmitted from the prompt engine 522 to a content generator, such as a LLM service 530. The LLM service 530 may be the same or similar to the LLM 230. For example, the LLM service 530 may be a text-to-text content generator.

Responsive to receiving the first prompt, the LLM service 530 generates a list of descriptors. As described above, the list of descriptors includes descriptive terms for the data to be iconized. For example, if the data to be iconized includes the term ‘furniture’ then a list of descriptors may include lamp, couch, and chair. The list of descriptors may include at least three items, at least five items, or at least ten items. In some cases, a user of the client device 510 may set a number of items to include in the list of descriptors upon submission of the visualization request. This may be performed by modifying a granularity setting for the icon image. That is, the user may select for the icon image to be refined or as close as possible to the data to be iconized. As such, the granularity setting for generation of the icon image may be increased. To achieve a higher level of granularity or refinement for the icon image, more descriptors may be generated by the LLM service 530, thereby providing more information down the line for the AI image generator.

The list of descriptors may be received by the prompt engine 522, which in turn, then configures a second prompt. The second prompt may be a request for an image to be generated based on the list of descriptors. In some cases, a user of the client device 510 may be able to review the list of descriptors and remove descriptors that are not relevant to the data to be iconized. For example, a prompt including the list of descriptors may be provided via the user interface 211 to the user. The user can select to remove one or more descriptors from the list before the second prompt is generated by the prompt engine 522.

Once the second prompt is configured, the prompt engine 522 transmits the second prompt to the AI image generator 532. As described above, the LLM service 530 and/or the AI image generator 532 may be locally executed as part of the application service 520 or may be remotely executed, and in some cases, hosted by a third party entirely. Responsive to receiving the second prompt, the AI image generator 532 generates an image based on the list of descriptors provided via the second prompt. The generated image is then provided to the prompt engine 522 or may be routed directly to an image processor 526. The image processor 526 may be the same or similar to the image processor 226, meaning that the image processor 526 modifies the image to generate an icon image. For example, the image processor 526 may reduce the size of the image to an icon size, remove the background of the image, and/or apply one or more filters to the image (e.g., changing color of the image, changing style of the color). Once the icon image is generated, the image processor 526 may also encode the icon image into text for storage. For example, once encoded, the icon image may be stored within the icon database 250.

The icon image, once generated by the image processor 526, is then transmitted to the visualization engine 524. Upon receipt of the icon image, the visualization engine 524 generates a visualization, such as a chart or graph, using the icon image. As described above, the visualization may be a chart in which the icon image is used as a datapoint for quantifying the underlying data. In some embodiments, the visualization request may include a request for the visualization to be animated. In such cases, the visualization may be submitted to an animation engine 528, which may be the same as the animation engine 228, for animation. Once the visualization is animated, the visualization including the icon image is transmitted to the client device 510.

Referring now to FIGS. 6A-6C, example GUIs 600A, 600B, and 600C illustrating various user experiences 612, 614, and 615 for providing one or more of the iconification functions are provided, according to an embodiment herein. Each of the GUIs 600A-C may be provided to a user of a client device, such as the client device 110, via a user interface, such as the user interface 211, during various steps of an iconification process. That is, each of the GUIs 600A-C illustrates different user experience that may be provided during the process 300 for providing the iconification functionality.

Starting with FIG. 6A, the GUI 600A illustrates the user experience 612. The user experience 612 may be the same or similar to the user experience 112. The user experience 612 includes user data 616 and a visualization menu 618. The user data 616 lists various datasets that a respective user interacts with. For example, the user may interact with one or more of the listed datasets of the user data 616 as part of a job or project. As such, the user experience 612 may provide a list of the user data 616 via the GUI 600A to allow the user to easily access corresponding datasets or to highlight commonly accessed datasets. As can be appreciated, this may facilitate productivity for the user with respect to interaction with the datasets.

The visualization menu 618 may provide or be a prompt via which a user can submit a visualization request. For example, the visualization menu 618 provides options 660, 662, and 664 into which a user can select desired content for a visualization. As illustrated, the option 660 allows a user to request that an icon image be used as datapoints within the visualization. That is, the user can select, via the option 660, to use an icon to quantify corresponding data as a metric within the visualization. For example, as illustrated in visualization 640 of the GUI 600B, if sales data indicates 600 elements of office furniture were sold, then the icon image 668 of an office chair may quantify and therefore represent 100 elements. As can be appreciated, a chart key or legend (not shown) may be provided with the visualization 640 for interpretation purposes.

The visualization menu 618 may also include options 662 and 664 that allow a user to select the values for the visualizations. That is, the options 662 and 664 allow a user to select what data to be used for the visualization. Here, the user selects a visualization to graph product sales (option 662) by product category (option 664). In some cases, the user may select the desired data for the visualization from the user data 616, which in other cases, the iconification function 221 or the application service 220 may determine relevant data from the user data 616 to be used within the visualization. As described above, trends or observations may be determined by one or more functions of the application service 220 and a recommendation may be provided to the user to generate a visualization of the trend or observation. In such cases, the options 660, 662, and 664, may be auto-populated by the iconification function 221 or the application service 220 based on the identified trend or observation. Once the options 660, 662, and 664 are selected, a user can select option 666 to submit the visualization request.

Once the visualization request is submitted, one or more steps of the iconification process 300 are performed to generate a visualization including the icon image. The GUI 600B illustrates the visualization 640. As shown, the visualization 640 is a bar chart in which icon images, such as the icon image 668. In some cases, the icon images are used to form a string 670 of icons. The string of icons 670 may be representative of an equivalent “bar” on a bar chart. As described above, the icon image 668 may be used as a datapoint to quantify the underlying data as a metric within the visualization 640. As such, the strong of icons 668 may be used to provide the overall quantification of the underlying data on the visualization 640.

The string 670 may also be used within to animate the visualization 640. Turning now to FIG. 6C, the GUI 600C provides the user experience 615 illustrating an animated visualization 642. As illustrated, the string 670 of the icon images 668 may be animated such as that the string 670 “flies into” the visualization 642, as indicated by the arrows 672. Animation of icon images 668 within the animated visualization 642 provides dynamic transitions and effects to the visualization 640. Animation can serve to visually guide a viewer's focus and engage their attention with the animated visualization 642, highlighted trends and concepts present in the data. As those skilled in the art readily appreciate, animation can include animated transitions in which the string 670 “flies” into or out of the animated visualization 642, fades in or out, appears or disappears, and the like.

Referring now to FIG. 7, FIG. 7 illustrates a computing system 701 that may be used for providing one or more iconification functionalities, as described herein. For example, the client device 110 may be or include the computing system 701. As illustrated, the computing system 701 includes a processing system 702 that includes a microprocessor and other circuitry that retrieves and executes software 705 from storage system 703. The processing system 702 may be implemented within a single processing device but may also be distributed across multiple processing devices or sub-systems that cooperate in executing program instructions. Examples of the processing system 702 include general purpose central processing units, graphical processing units, application specific processors, and logic devices, as well as any other type of processing device, combinations, or variations thereof.

The storage system 703 may comprise any computer readable storage media readable by processing system 702 and capable of storing software 705. The storage system 703 may include volatile and nonvolatile, removable and non-removable media implemented in any method or technology for storage of information, such as computer readable instructions, data structures, program modules, or other data. Examples of storage media include random access memory, read only memory, magnetic disks, optical disks, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations the storage system 703 may also include computer readable communication media over which at least some of the software 705 may be communicated internally or externally. The storage system 703 may be implemented as a single storage device but may also be implemented across multiple storage devices or sub-systems co-located or distributed relative to each other. The storage system 703 may comprise additional elements, such as a controller capable of communicating with the processing system 702 or possibly other systems.

The software 705 (including the iconification functionality 706) may be implemented in program instructions and among other functions may, when executed by the processing system 702, direct the processing system 702 to operate as described with respect to the various operational scenarios, sequences, and processes illustrated herein. For example, the software 705 may include program instructions for implementing one or more Examples of the iconification functionality, as described herein.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. The software 705 may include additional processes, programs, or components, such as operating system software, virtualization software, or other application software. The software 705 may also comprise firmware or some other form of machine-readable processing instructions executable by the processing system 702.

In general, the software 705 may, when loaded into the processing system 702 and executed, transform a suitable apparatus, system, or device (of which computing system 701 is representative) overall from a general-purpose computing system into a special-purpose computing system customized to support insights features, functionality, and user experiences. Indeed, encoding the software 705 on the storage system 703 may transform the physical structure of the storage system 703. The specific transformation of the physical structure may depend on various factors in different implementations of this description. Examples of such factors may include, but are not limited to, the technology used to implement the storage media of the storage system 703 and whether the computer-storage media are characterized as primary or secondary storage, as well as other factors.

For example, if the computer readable storage media are implemented as semiconductor-based memory, the software 705 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 707 may include communication connections and devices that allow for communication with other computing systems (not shown) over communication networks (not shown). Examples of connections and devices that together allow for inter-system communication may include network interface cards, antennas, power amplifiers, RF circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here.

Communication between the computing system 701 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses and backplanes, or any other type of network, combination of network, or variation thereof. The aforementioned communication networks and protocols are well known and need not be discussed at length here.

While some examples of methods and systems herein are described in terms of software executing on various machines, the methods and systems may also be implemented as specifically-configured hardware, such as field-programmable gate array (FPGA) specifically to execute the various methods according to this disclosure. For example, examples can be implemented in digital electronic circuitry, or in computer hardware, firmware, software, or in a combination thereof. In one example, a device may include a processor or processors. The processor comprises a computer-readable medium, such as a random access memory (RAM) coupled to the processor. The processor executes computer-executable program instructions stored in memory, such as executing one or more computer programs. Such processors may comprise a microprocessor, a digital signal processor (DSP), an application-specific integrated circuit (ASIC), field programmable gate arrays (FPGAs), and state machines. Such processors may further comprise programmable electronic devices such as PLCs, programmable interrupt controllers (PICs), programmable logic devices (PLDs), programmable read-only memories (PROMs), electronically programmable read-only memories (EPROMs or EEPROMs), or other similar devices.

Such processors may comprise, or may be in communication with, media, for example one or more non-transitory computer-readable media, which may store processor-executable instructions that, when executed by the processor, can cause the processor to perform methods according to this disclosure as carried out, or assisted, by a processor. Examples of non-transitory computer-readable medium may include, but are not limited to, an electronic, optical, magnetic, or other storage device capable of providing a processor, such as the processor in a web server, with processor-executable instructions. Other examples of non-transitory computer-readable media include, but are not limited to, a floppy disk, CD-ROM, magnetic disk, memory chip, ROM, RAM, ASIC, configured processor, all optical media, all magnetic tape or other magnetic media, or any other medium from which a computer processor can read. The processor, and the processing, described may be in one or more structures, and may be dispersed through one or more structures. The processor may comprise code to carry out methods (or parts of methods) according to this disclosure.

The foregoing examples and descriptions are described herein in the context of systems and methods for providing one or more iconification functionalities for visualization generation. Those of ordinary skill in the art will realize that these descriptions are illustrative only and is not intended to be in any way limiting. Reference is made in detail to implementations of examples as illustrated in the accompanying drawings. The same reference indicators are used throughout the drawings and the description to refer to the same or like items.

In the interest of clarity, not all of the routine features of the examples described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another. That is, the foregoing description of some examples has been presented only for the purpose of illustration and description and is not intended to be exhaustive or to limit the disclosure to the precise forms disclosed. Numerous modifications and adaptations thereof will be apparent to those skilled in the art without departing from the spirit and scope of the disclosure.

Reference herein to an example or implementation means that a particular feature, structure, operation, or other characteristic described in connection with the example may be included in at least one implementation of the disclosure. The disclosure is not restricted to the particular examples or implementations described as such. The appearance of the phrases “in one example,” “in an example,” “in one implementation,” or “in an implementation,” or variations of the same in various places in the specification does not necessarily refer to the same example or implementation. Any particular feature, structure, operation, or other characteristic described in this specification in relation to one example or implementation may be combined with other features, structures, operations, or other characteristics described in respect of any other example or implementation.

Use herein of the word “or” is intended to cover inclusive and exclusive OR conditions. In other words, A or B or C includes any or all of the following alternative combinations as appropriate for a particular usage: A alone; B alone; C alone; A and B only; A and C only; B and C only; and A and B and C.

### EXAMPLES

These illustrative examples are mentioned not to limit or define the scope of this disclosure, but rather to provide examples to aid understanding thereof. Illustrative examples are discussed above in the Detailed Description, which provides further description. Advantages offered by various examples may be further understood by examining this specification.

As used below, any reference to a series of examples is to be understood as a reference to each of those examples disjunctively (e.g., “Examples 1-4” is to be understood as “Examples 1, 2, 3, or 4”).

Example 1 is a system comprising: a non-transitory computer-readable medium; and a processor communicatively coupled to the non-transitory computer-readable medium, the processor configured to execute processor-executable instructions stored in the non-transitory computer-readable medium to: receive, by an iconification function, a visualization request from a client device; determine, by a prompt engine of the iconification function, data to iconize based on the visualization request; generate, by the prompt engine of the iconification function, a first prompt based on the data to iconize; determine, by the iconification function, a plurality of descriptors based on the first prompt; generate, by the prompt engine of the iconification function, a second prompt based on the plurality of descriptors; generate, by the iconification function, an image based on the second prompt; generate, by the iconification function, an icon image based on the image; generate, by the iconification function, a visualization comprising the icon image; and transmit, by the iconification function, the visualization to the client device.

Example 2 is the system of any previous or subsequent Example, wherein the processor-executable instructions to generate, by the iconification function, the icon image based on the image cause the processor to further execute processor-executable instructions stored in the non-transitory computer-readable medium to: reduce, by an image processor of the iconification function, a size of the image; and remove, by the image processor of the iconification function, a background of the image.

Example 3 is the system of any previous or subsequent Example, wherein the processor-executable instructions to generate the image, by the prompt engine of the iconification function, based on the second prompt cause the processor to further execute processor-executable instructions stored in the non-transitory computer-readable medium to: submit, by the prompt engine of the iconification function, the second prompt to a content generator, wherein the content generator: comprises a text-to-image model; and generates the image based on the second prompt.

Example 4 is the system of any previous or subsequent Example, wherein the processor-executable instructions to generate the plurality of descriptors, by the prompt engine of the iconification function, based on the first prompt cause the processor to further execute processor-executable instructions stored in the non-transitory computer-readable medium to: submit, by the prompt engine of the iconification function, the first prompt to a content generator, wherein the content generator: comprises a text-to-text language model; and generates the plurality of descriptors based on the first prompt.

Example 5 is the system of any previous or subsequent Example, wherein the processor further executes processor-executable instructions stored in the non-transitory computer-readable medium to: encode, by the iconification function, the icon image into text; and store, by the iconification function, the text associated with the icon image in an icon database.

Example 6 is the system of any previous or subsequent Example, wherein the processor further executes processor-executable instructions stored in the non-transitory computer-readable medium to: receive, by the iconification function, second user data from a second client device; generate, by the iconification function, a recommendation comprising the icon image based on the second user data; and provide, to a second client device, the recommendation comprising the icon image.

Example 7 is the system of any previous or subsequent Example, wherein the processor further executes processor-executable instructions stored in the non-transitory computer-readable medium to: receive, by the iconification function, a request to animate the visualization from the client device; generate, by an animation engine of the iconification function, a visualization animation based on the request; and transmit, by the iconification function, the visualization animation to the client device.

Example 8 is a method of generating iconified charts comprising: receiving, by an iconification function, a visualization request from a client device; determining, by a prompt engine of the iconification function, data to iconize based on the visualization request; generating, by the prompt engine of the iconification function, a first prompt based on the data to iconize; determining, by the iconification function, a plurality of descriptors based on the first prompt; generating, by the prompt engine of the iconification function, a second prompt based on the plurality of descriptors; generating, by the iconification function, an image based on the second prompt; generating, by the iconification function, an icon image based on the image; generating, by the iconification function, a visualization comprising the icon image; and transmitting, by the iconification function, the visualization to the client device.

Example 9 is the method of any previous or subsequent Example, wherein determining, by the iconification function, the plurality of descriptors based on the first prompt further comprises: submitting, to content generator, the first prompt generated by the prompt engine, wherein the content generator comprises a text-to-text large language model; and receiving, by the prompt engine of the iconification function, the plurality of descriptors based on the first prompt from the content generator.

Example 10 is the method of any previous or subsequent Example, wherein generating, by the iconification function, the image based on the second prompt further comprises: submitting, to a content generator, the second prompt based on the plurality of descriptors, wherein the content generator comprises a text-to-image model that generates the image based on the plurality of descriptors.

Example 11 is the method of any previous or subsequent Example, wherein generating, by the iconification function, the icon image based on the image further comprises modifying, by an image processor, the image by performing one or more of: reducing a size of the image to generate the icon image; or removing a background of the image to generate the icon image.

Example 12 is the method of any previous or subsequent Example, wherein the method further comprises: receiving, by the iconification function, a request to animate the visualization from the client device; generating, by an animation engine of the iconification function, a visualization animation based on the request; and transmitting, by the iconification function, the visualization animation to the client device.

Example 13 is the method of any previous or subsequent Example, wherein the visualization comprises a graph and generating, by the iconification function, the visualization comprising the icon image further comprises: generating, by the iconification function, the graph responsive to the visualization request, wherein the icon image quantifies the data as a metric on the graph.

Example 14 is the method of any previous or subsequent Example, wherein determining, by the prompt engine of the iconification function, the data to iconize based on the visualization request further comprises: determining, by the prompt engine of the iconification function, the data based on user data associated with the client device.

Example 15 is the method of any previous or subsequent Example, wherein the method further comprises: encoding, by the iconification function, the icon image into text; and storing, by the iconification function, the text associated with the icon image in an icon database.

Example 16 is the method of any previous or subsequent Example, wherein generating, by the iconification function, the visualization comprising the icon image further comprises: generating, by the iconification function, an icon string, wherein the icon string comprises a plurality of icon images; and generating, by the iconification function, a chart comprising the icon string, wherein the icon string quantifies the data from the visualization request as a metric within the chart.

Example 17 is a non-transitory computer-readable medium comprising processor-executable instructions configured to cause one or more processors to: receive, by an iconification function, a visualization request from a client device; determine, by a prompt engine of the iconification function, data to iconize based on the visualization request; generate, by the prompt engine of the iconification function, a first prompt based on the data to iconize; determine, by the iconification function, a plurality of descriptors based on the first prompt; generate, by the prompt engine of the iconification function, a second prompt based on the plurality of descriptors; generate, by the iconification function, an image based on the second prompt; generate, by the iconification function, an icon image based on the image; generate, by the iconification function, a visualization comprising the icon image; and transmit, by the iconification function, the visualization to the client device.

Example 18 is the non-transitory computer-readable medium of any previous or subsequent Example, wherein the visualization comprises an chart and the processor-executable instructions to generate, by the iconification function, the visualization comprising the icon image cause the one or more processors to further execute processor-executable instructions stored in the non-transitory computer-readable medium to: generate, by the iconification function, the chart responsive to the visualization request, wherein the icon image quantifies the data as a metric on the chart.

Example 19 is the non-transitory computer-readable medium of any previous or subsequent Example, wherein the processor-executable instructions stored in the non-transitory computer-readable medium are further configured to cause the one or more processors to: determine, by the iconification function, that the image comprises poor quality content; generate, by the prompt engine of the iconification function, a third prompt; generate, by the iconification function, a second image based on the third prompt; and generate, by the iconification function, the icon image based on the second image.

Example 20 is the non-transitory computer-readable medium of any previous or subsequent Example, wherein: the processor-executable instructions to generate the plurality of descriptors, by the prompt engine of the iconification function, based on the first prompt cause the one or more processors to further execute processor-executable instructions stored in the non-transitory computer-readable medium to submit, by the prompt engine of the iconification function, the first prompt to a content generator, wherein the content generator: comprises a text-to-text language model; and generates the plurality of descriptors based on the first prompt; and wherein the processor-executable instructions to generate the image, by the prompt engine of the iconification function, based on the second prompt cause the one or more processors to further execute processor-executable instructions stored in the non-transitory computer-readable medium to submit, by the prompt engine of the iconification function, the second prompt to a content generator, wherein the content generator: comprises a text-to-image model; and generates the image based on the second prompt.

That which is claimed is:

1. A system comprising:
a non-transitory computer-readable medium; and
a processor communicatively coupled to the non-transitory computer-readable medium, the processor configured to execute processor-executable instructions stored in the non-transitory computer-readable medium to:
receive, by an iconification function, a visualization request from a client device;
determine, by a prompt engine of the iconification function, data to iconize based on the visualization request;
generate, by the prompt engine of the iconification function, a first prompt based on the data to iconize;
determine, by the iconification function, a plurality of descriptors based on the first prompt;
generate, by the prompt engine of the iconification function, a second prompt based on the plurality of descriptors;
generate, by the iconification function, an image based on the second prompt;
generate, by the iconification function, an icon image based on the image;
generate, by the iconification function, a visualization comprising the icon image; and
transmit, by the iconification function, the visualization to the client device.

2. The system of claim 1, wherein the processor-executable instructions to generate, by the iconification function, the icon image based on the image cause the processor to further execute processor-executable instructions stored in the non-transitory computer-readable medium to:
reduce, by an image processor of the iconification function, a size of the image; and
remove, by the image processor of the iconification function, a background of the image.

3. The system of claim 1, wherein the processor-executable instructions to generate the image, by the prompt engine of the iconification function, based on the second prompt cause the processor to further execute processor-executable instructions stored in the non-transitory computer-readable medium to:
submit, by the prompt engine of the iconification function, the second prompt to a content generator, wherein the content generator:
comprises a text-to-image model; and
generates the image based on the second prompt.

4. The system of claim 1, wherein the processor-executable instructions to generate the plurality of descriptors, by the prompt engine of the iconification function, based on the first prompt cause the processor to further execute processor-executable instructions stored in the non-transitory computer-readable medium to:
submit, by the prompt engine of the iconification function, the first prompt to a content generator, wherein the content generator:
comprises a text-to-text language model; and
generates the plurality of descriptors based on the first prompt.

5. The system of claim 1, wherein the processor further executes processor-executable instructions stored in the non-transitory computer-readable medium to:
encode, by the iconification function, the icon image into text; and
store, by the iconification function, the text associated with the icon image in an icon database.

6. The system of claim 1, wherein the processor further executes processor-executable instructions stored in the non-transitory computer-readable medium to:
receive, by the iconification function, second user data from a second client device;
generate, by the iconification function, a recommendation comprising the icon image based on the second user data; and
provide, to a second client device, the recommendation comprising the icon image.

7. The system of claim 1, wherein the processor further executes processor-executable instructions stored in the non-transitory computer-readable medium to:
receive, by the iconification function, a request to animate the visualization from the client device;
generate, by an animation engine of the iconification function, a visualization animation based on the request; and
transmit, by the iconification function, the visualization animation to the client device.

8. A method of generating iconified visualizations comprising:
receiving, by an iconification function, a visualization request from a client device;
determining, by a prompt engine of the iconification function, data to iconize based on the visualization request;
generating, by the prompt engine of the iconification function, a first prompt based on the data to iconize;
determining, by the iconification function, a plurality of descriptors based on the first prompt;
generating, by the prompt engine of the iconification function, a second prompt based on the plurality of descriptors;
generating, by the iconification function, an image based on the second prompt;
generating, by the iconification function, an icon image based on the image;
generating, by the iconification function, a visualization comprising the icon image; and
transmitting, by the iconification function, the visualization to the client device.

9. The method of claim 8, wherein determining, by the iconification function, the plurality of descriptors based on the first prompt further comprises:
submitting, to content generator, the first prompt generated by the prompt engine, wherein the content generator comprises a text-to-text large language model; and
receiving, by the prompt engine of the iconification function, the plurality of descriptors based on the first prompt from the content generator.

10. The method of claim 8, wherein generating, by the iconification function, the image based on the second prompt further comprises:
submitting, to a content generator, the second prompt based on the plurality of descriptors, wherein the content generator comprises a text-to-image model that generates the image based on the plurality of descriptors.

11. The method of claim 8, wherein generating, by the iconification function, the icon image based on the image further comprises modifying, by an image processor, the image by performing one or more of:
reducing a size of the image to generate the icon image; or
removing a background of the image to generate the icon image.

12. The method of claim 8, wherein the method further comprises:
receiving, by the iconification function, a request to animate the visualization from the client device;
generating, by an animation engine of the iconification function, a visualization animation based on the request; and
transmitting, by the iconification function, the visualization animation to the client device.

13. The method of claim 8, wherein the visualization comprises a graph and generating, by the iconification function, the visualization comprising the icon image further comprises:
generating, by the iconification function, the graph responsive to the visualization request, wherein the icon image quantifies the data as a metric on the graph.

14. The method of claim 8, wherein determining, by the prompt engine of the iconification function, the data to iconize based on the visualization request further comprises:
determining, by the prompt engine of the iconification function, the data based on user data associated with the client device.

15. The method of claim 8, wherein the method further comprises:
encoding, by the iconification function, the icon image into text; and
storing, by the iconification function, the text associated with the icon image in an icon database.

16. The method of claim 8, wherein generating, by the iconification function, the visualization comprising the icon image further comprises:
generating, by the iconification function, an icon string, wherein the icon string comprises a plurality of icon images; and
generating, by the iconification function, a chart comprising the icon string, wherein the icon string quantifies the data from the visualization request as a metric within the chart.

17. A non-transitory computer-readable medium comprising processor-executable instructions configured to cause one or more processors to:
receive, by an iconification function, a visualization request from a client device;
determine, by a prompt engine of the iconification function, data to iconize based on the visualization request;
generate, by the prompt engine of the iconification function, a first prompt based on the data to iconize;
determine, by the iconification function, a plurality of descriptors based on the first prompt;
generate, by the prompt engine of the iconification function, a second prompt based on the plurality of descriptors;
generate, by the iconification function, an image based on the second prompt;
generate, by the iconification function, an icon image based on the image;
generate, by the iconification function, a visualization comprising the icon image; and
transmit, by the iconification function, the visualization to the client device.

18. The non-transitory computer-readable medium of claim 17, wherein the visualization comprises a chart and the processor-executable instructions to generate, by the iconification function, the visualization comprising the icon image cause the one or more processors to further execute processor-executable instructions stored in the non-transitory computer-readable medium to:
generate, by the iconification function, the chart responsive to the visualization request, wherein the icon image quantifies the data as a metric on the chart.

19. The non-transitory computer-readable medium of claim 17, wherein the processor-executable instructions stored in the non-transitory computer-readable medium are further configured to cause the one or more processors to:
determine, by the iconification function, that the image comprises poor quality content;
generate, by the prompt engine of the iconification function, a third prompt;
generate, by the iconification function, a second image based on the third prompt; and
generate, by the iconification function, the icon image based on the second image.

20. The non-transitory computer-readable medium of claim 17, wherein:
the processor-executable instructions to generate the plurality of descriptors, by the prompt engine of the iconification function, based on the first prompt cause the one or more processors to further execute processor-executable instructions stored in the non-transitory computer-readable medium to submit, by the prompt engine of the iconification function, the first prompt to a content generator, wherein the content generator:
comprises a text-to-text language model; and
generates the plurality of descriptors based on the first prompt; and
wherein the processor-executable instructions to generate the image, by the prompt engine of the iconification function, based on the second prompt cause the one or more processors to further execute processor-executable instructions stored in the non-transitory computer-readable medium to submit, by the prompt engine of the iconification function, the second prompt to a content generator, wherein the content generator:
comprises a text-to-image model; and
generates the image based on the second prompt.
